(19) United States
(12) Patent Application Publication
(10) Pub. No.: US 2003/0039470 A1
(43) Pub. Date: Feb. 27, 2003

(54) Method and system for seamless playback of video/audio data and user agent data

(76) Inventors: Masato Otsuka, Torrance, CA (US); Ramaswamy Devarajan, Long Beach, CA (US); Sanjay Kulkarni, Torrance, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/014,123

(22) Filed: Oct. 26, 2001

Related U.S. Application Data
(60) Provisional application No. 60/313,158, filed on Aug. 17, 2001.

(51) Int. Cl. H04N 5/781

(52) U.S. Cl. 386/95; 386/126

(57) ABSTRACT

A system and method of providing seamless playback of video data and corresponding user agent data in an optical disc player. The method entails transferring a logical unit of video data from a source to a track buffer while not transferring user agent data, and then transferring user agent data from the source to a user agent buffer while not transferring video data. Another method entails transferring video data from a source to a track buffer concurrently with the transfer of user agent data from the source to a user agent buffer. Yet another method entails using two optical disc reading mechanisms to simultaneously read synchronized video data and user agent data. Another method relates to using pointers to associate video data with user agent data to provide synchronized displaying of both types of data.

### CROSS-REFERENCE TO A RELATED PATENT APPLICATION

This application claims the benefit of Provisional Patent Application, Serial No. 60/313,158, filed on Aug. 17, 2001, and entitled “Method and System for Seamless Playback of DVD video/audio data and user agent data stored in an Optical Disc,” which is incorporated herein by reference.

### FIELD OF THE INVENTION

This invention relates generally to optical disc players, such as digital versatile disc (DVD) players and other formats, and in particular, to a method and system for seamless playback of video/audio data and user agent data stored on a local optical disc and/or at an external source.

### BACKGROUND OF THE INVENTION

Optical disc players with user agent program playback capability can operate in two modes: in a video playback mode and a user agent mode. In video playback mode, the optical disc player functions to access and display video/audio content stored on the local optical disc, such as would a standard DVD player, or at an external source (such as a server across the Internet or Intranet, an external hard drive, an external optical drive). In user agent mode, the optical disc player is configured to run a user agent program to access user agent documents (e.g. access HTML documents containing text, images, such as JPEG and GIF images, animated content, etc.) available from the local optical disc or from an external source.

FIG. 1 illustrates a display screen of an exemplary user agent document 100 in user agent mode. The user agent document 100 may comprise a title section 102, an information section 104 providing information about the video segment being displayed, a video sub-window 106 for displaying the video segment, and navigation buttons 108 for navigating between different user agent documents and/or video segments. It may be desirable to display the user agent document 100 including the video segment 106 seamlessly to a user. That is, the accessing and displaying of the user agent document 100 and the video segment 106 should appear to a user as being performed simultaneously.

FIG. 2 illustrates a top view of an exemplary optical disc 200 that stores video/audio data (e.g. DVD video/audio data) as well as user agent data (such as HTML documents, texts, graphics, animation, scripts, and others). The optical disc 200 may include an inner annular region 202 for storing video/audio data, and an outer annular region 204 for storing user agent data. The reading head of an optical disc player has to move between the video/audio data region 202 and the user agent data region 204 to read both types of data. As discussed above, it would be desirable for the playback of both the video/audio data and the user agent data be seamless to a user. However, the requirements for seamless data flow for standard DVD players present a problem for reading both video/audio data and the user agent data in a seamless manner, as will be explained with reference to FIG. 3.

FIG. 3 illustrates a functional block diagram of a typical DVD player 300 for reading video/audio data from a DVD disc 302. The DVD player 300 consists of a drive 304 for reading the video/audio data from the disc 302, a track buffer 306 for temporarily storing video/audio data to be decoded, and a DVD decoder 308 for decoding the read video/audio data. The DVD Specifications for Read-Only Disc, Part 3 Video Specifications requires a minimum reading data rate (typically referred to as “1×”) from the disc 302 to the track buffer 306 to provide seamless decoding of video/audio data. If the data rate falls below the required data rate 1×, there may not be enough data in the track buffer 306 for the DVD decoder 308 to properly process the data, and consequently the system may hang up. This condition is termed in the art as a track buffer underflow.

For standard DVD discs containing only video/audio data, track buffer underflow does not typically occur since standard DVD players are designed to read data from discs at or above the required data rate 1×. However, if the local DVD disc 200 has both video/audio data and user agent data, the time to move the reading head between the video/audio data region 202 and the user agent data region 204 of the disc 200, and the time to read the user agent data may cause the video/audio data rate to the track buffer 306 to fall below the required data rate of 1×. This will cause a track buffer underflow which may cause the system to hang up.

Thus, there is a need for a method and system for seamless playback of video/audio data and user agent data stored on a local optical disc and/or at an external source without causing a track buffer underflow.

### BRIEF DESCRIPTION OF THE DRAWINGS

FIG. 1 illustrates a display screen of an exemplary user agent document in user agent mode;

FIG. 2 illustrates a top view of an exemplary optical disc that stores video/audio data as well as user agent data;

FIG. 3 illustrates a functional block diagram of a typical DVD player for reading video/audio data from a DVD disc;

FIG. 4 illustrates a functional block diagram of an exemplary optical disc player in accordance with the invention;

FIG. 5 illustrates a directory tree for video/audio data and user agent data in accordance with the invention;

FIG. 6 illustrates flow diagrams of methods of providing seamless playback of video/audio data and user agent data in accordance with the invention; and

FIG. 7 illustrates a functional block diagram of an exemplary optical disc player that implements two drive read heads in accordance with the invention.

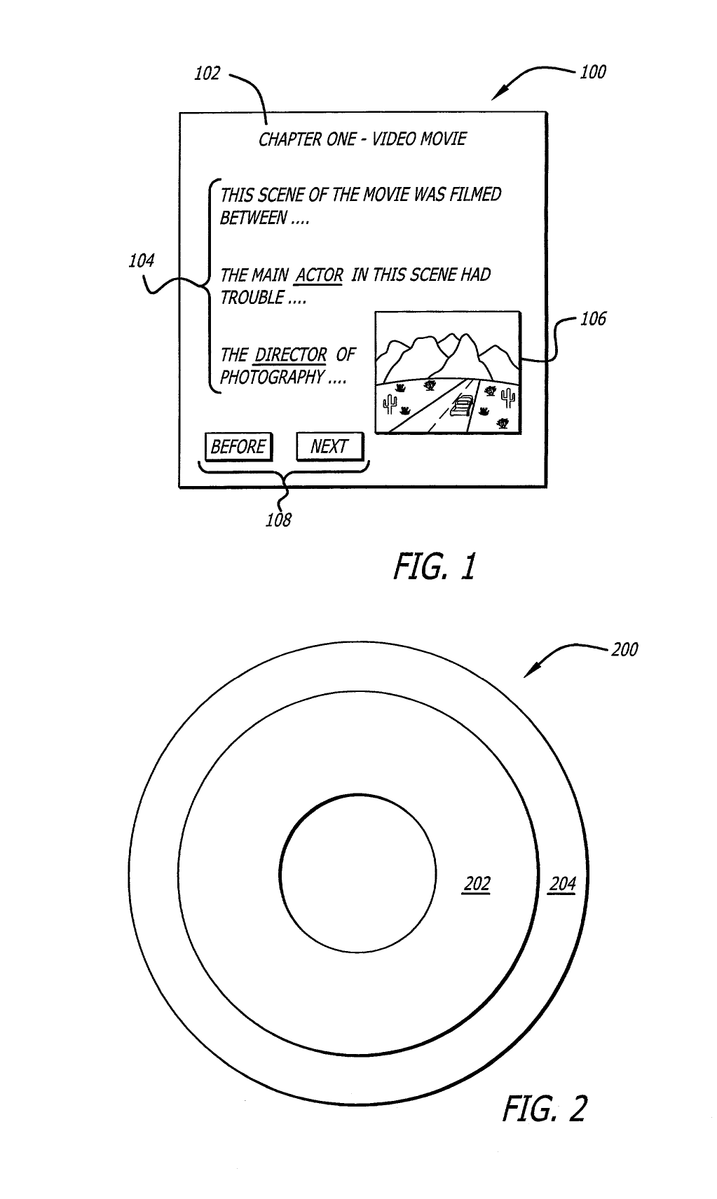

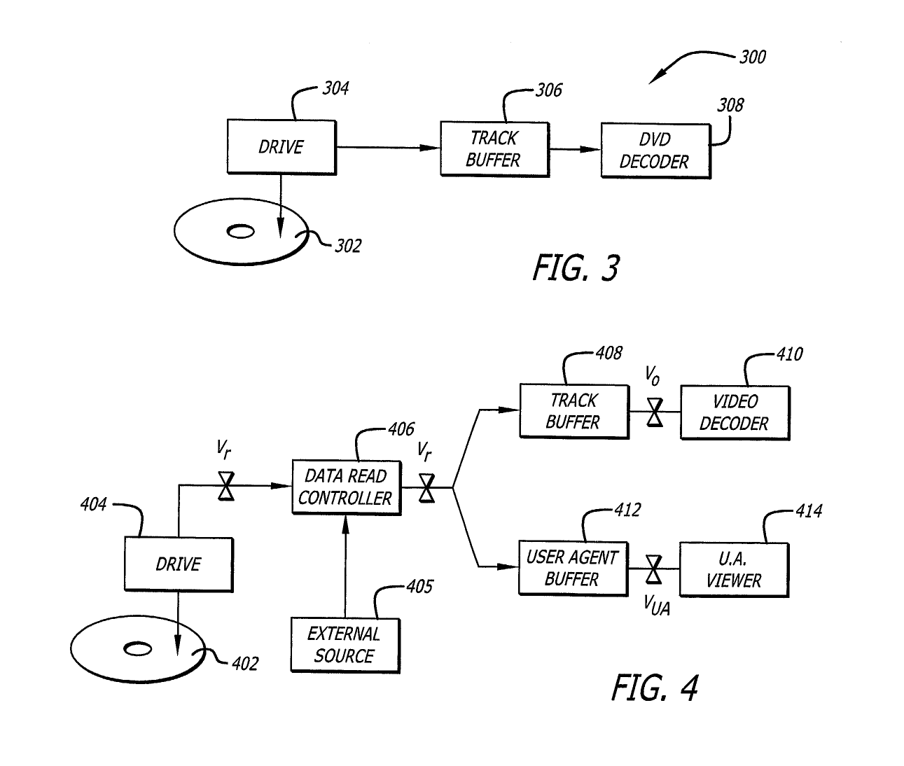

### SUMMARY OF THE INVENTION

An aspect of the invention relates to a method for providing seamless playback of video data and user agent data by an optical disc player. The method comprises transferring a program chain (PGC) of video data from a source to a track buffer while not transferring user agent data and transferring a set of user agent data associated with the program chain (PGC) while not transferring video data. This meets the DVD Specifications for Read-Only Disc, Part 3, Video Specifications which guarantees seamless playback within a PGC. The fact that the transfer of the program chain (PGC) is performed separately from the transfer of the user agent data allows the data transfer rate to be at the 1× rate or above as required by the DVD specifications for Read Only Disc, Part 3, Video Specifications (Annex K).

In the exemplary method, the transfer of the program chain (PGC) can be performed before or after the transfer of the associated user agent data. The method may further entail decoding the program chain (PGC) in order to display the video segment, and also decoding of the user agent data in order to display the user agent data concurrently with the associated program chain (PGC). The source of the program chain (PGC) video data and/or the user agent data may be a local optical disc or a source external to the optical disc player (e.g. a server on a wide area network or local area network, an external hard drive, an external optical disc drive, etc.).

Another aspect of the invention relates to an optical disc player that can implement the above methodology. Such optical disc player comprises a track buffer to temporarily store video data, a user agent buffer to temporarily store user agent data, and a read data controller to cause a transfer of a program chain (PGC) of video data from a source to the track buffer while not transferring user agent data, and to cause a transfer of a set of user agent data (associated with the program chain (PGC) of video data) from the source to the user agent buffer while not transferring the program chain (PGC) of video data. As stated above, the fact that the reading of the program chain (PGC) is performed separately from the reading of the user agent data allows the data transfer rate to be at the 1× rate or above as required by the DVD specifications for Read Only Disc, Part 3, Video Specifications (Annex K).

In the exemplary embodiment, the data read controller of the optical disc player can perform the transfer of the program chain (PGC) of video data before or after the transfer of the associated user agent data. The optical disc player further comprises a video decoder to decode the program chain of video data in order to display the program chain of video data, and also a user agent viewer to decode the user agent data in order to display the user agent data. In addition, the optical disc player comprises an optical disc reader to read the program chain (PCG) of video data and/or user agent data from a local optical disc. Also, the optical disc player comprises an interface to receive video data and/or user agent data from an external source (e.g. a server on a wide area network or local area network, an external hard drive, an external optical disc drive, etc.).

Another aspect of the invention relates to another method for providing seamless playback of video data and user agent data by an optical disc player. The method comprises transferring a program chain (PGC) of video data from a source to a track buffer and transferring a set of user agent data (associated with the program chain (PGC) of video data) from the source to the user agent buffer concurrently with the transferring of program chain of video data. According to the exemplary method, the transfer of the user agent data is performed in a manner that prevents an underflow of the track buffer and/or an overflow of the user agent buffer. Also, the transfer of the program chain (PGC) of video data is performed in a manner that prevents an underflow of the user agent buffer and/or an overflow of the track buffer.

The method may further entail decoding the program chain (PGC) of video data in order to display the video data. In addition, the method may also entail decoding the user agent data in order to display the user agent data. The source of the video data and/or the user agent data may be a local optical disc or a source external to the local optical disc player (e.g. a server on a wide area network or local area network, an external hard drive, an external optical disc drive, etc.).

Yet another aspect of the invention relates to an optical disc player that implements the above methodology. The optical disc player comprises a track buffer to temporarily store video data, a user agent buffer to temporarily store user agent data, and a data read controller to cause a transfer of a program chain (PGC) of video data from a source to the track buffer concurrently with a transfer of a set of user agent data from the source to the user agent buffer. In the exemplary optical disc player, the data read controller causes the transfer of the program chain (PGC) of video data in a manner that prevents an underflow of the user agent buffer and/or an overflow of the track buffer. Also, the data read controller causes the transfer of the user agent data in a manner that prevents an underflow of the track buffer and/or an overflow of the user agent buffer.

Also in the exemplary embodiment, the optical disc player includes a video decoder to decode the program chain (PGC) of video data in order to display the video data. The optical disc player further includes a user agent viewer to render the user agent data in order to display the user agent data. The exemplary optical disc further comprises an optical disc reader to read the program chain (PGC) of video data and/or the user agent data from a local optical disc and/or from an external source (e.g. a server on a wide area network or local area network, an external hard drive, an external optical disc drive, etc.).

Yet another aspect of the invention relates to a method of associating video data with user agent data to provide synchronization of video data and user agent data. The method entails providing a first directory table containing a plurality of program chains of video data and respective pointers to a plurality of sets of user agent data associated respectively with the plurality of program chains of video data. In this manner, the accessing of a program chain (PGC) provides information as to the corresponding user agent data in order to provide a synchronization display of the video data and the corresponding user agent data. In the exemplary embodiment, a second directory table is provided containing the plurality of sets of user agent data and respective pointers to one or more objects associated respectively with the plurality of sets of user agent data.

Still another aspect of the invention relates to another method of associating video data with user agent data to provide synchronization of video data and user agent data. The method entails providing a first directory table containing a plurality of sets of user agent data and respective pointers to a plurality of program chains (PGC) of video data associated respectively with the sets of user agent data. In this manner, the accessing of a set of user agent data provides information as to the corresponding program chain (PGC) of video data in order to provide a synchronous display of the video data and the corresponding user agent data. In the exemplary embodiment, the first directory table may further contain respective pointers to one or more objects associated respectively with the plurality of sets of user agent data.

Another aspect of the invention relates to another method for providing seamless playback of video data and user agent data by an optical disc player. The method comprises transferring a set of video data from a source to a track buffer and transferring a set of user agent data (associated with the video data) from the source to the user agent buffer simultaneously. This is achieved by having two read heads in the drive read mechanism to read user agent data and video data simultaneously. One drive head is used to read user agent data while the other drive head is used to read video data. Video data and user agent data that is read can be synchronized using a drive read controller. According to the exemplary method, the transfer of video data is performed in a manner that prevents an underflow and overflow of the track buffer. Also, the transfer of user agent data is performed in a manner that prevents an underflow and overflow of the user agent buffer.

Yet another aspect of the invention relates to an optical disc player that implements the above methodology. The optical disc player comprises a track buffer to temporarily store video data, a user agent buffer to temporarily store user agent data, an optical disc drive having a first reading mechanism to read video data and a second reading mechanism to read user agent data both from a local optical disc, and a data read controller to cause the second reading mechanism to read user agent data simultaneous with the first reading mechanism reading of the video data, and to further cause a transfer of the video data and user agent data respectively to the track buffer and the user agent buffer.

Other aspects, features and techniques of the invention will become apparent to one skilled in the relevant art in view of the following detailed description of the invention.

### DETAILED DESCRIPTION OF THE INVENTION

I. Overview

An aspect of the invention relates to a method and system for seamless playback of video/audio data and user agent data stored on a local optical disc or at an external source. According to the invention, there are three methods for providing seamless playback of video/audio data and user agent data without causing a track buffer underflow. The first method entails performing the reading of the user agent data before or after the reading of a consecutive program chain (PGC) (a logical unit of video/audio data). The second method entails performing the reading of the user agent data concurrently with the reading of the video/audio data at a data rate such that track buffer underflow does not occur, i.e. a data rate greater than the required data rate of 1×. The third method entails reading user agent data and video data simultaneously by means of a drive mechanism that has two heads to read user agent data and video data simultaneously.

FIG. 4 illustrates a block diagram of an optical disc player 400 in accordance with the invention. The optical disc player 400 may be configured as a dedicated optical disc player. The optical disc player 400 is capable of seamlessly playing back video/audio data and user agent data stored on a local optical disc 402 and/or an external source. The optical disc player 400 can use both methods of seamless playback of video/audio data and user agent data in accordance with the invention. The optical disc player 400 comprises an optical disk drive 404 to read the data from the local optical disc 402, an external source interface 405 to receive data from an external source, a data read controller 406 to control the retrieval of data from the local optical disc 402 and/or the external source and initially store the read data in a buffer, a track buffer 408 for temporarily storing video/audio data to be decoded, and a video decoder 410 for decoding the read video/audio data. In addition, the optical disc player 400 comprises a user agent buffer 412 to temporarily store user agent data and a user agent viewer 414 to render the read user agent data for display purposes.

II. Method of Associating Video Segments with Corresponding User Agent Documents

Typically, the local optical disc 402 and/or the external source contains sets of user agent data that are associated with sets of video/audio data segments (i.e. program chains (PGCs). Thus, there is a need to associate the sets of user agent data with the corresponding PGCs. Therefore, one aspect of the invention is a method of associating sets of user agent data to corresponding PGCs. In accordance with the method of the invention, an association information file ( ) file is stored on the local optical disc 402 or at the external source. This file contains, among other information, a pointer to a PGC directory table stored on the local optical disc or the external source. The PGC directory table contains the sets of PGCs and corresponding pointers to the corresponding sets of user agent data.

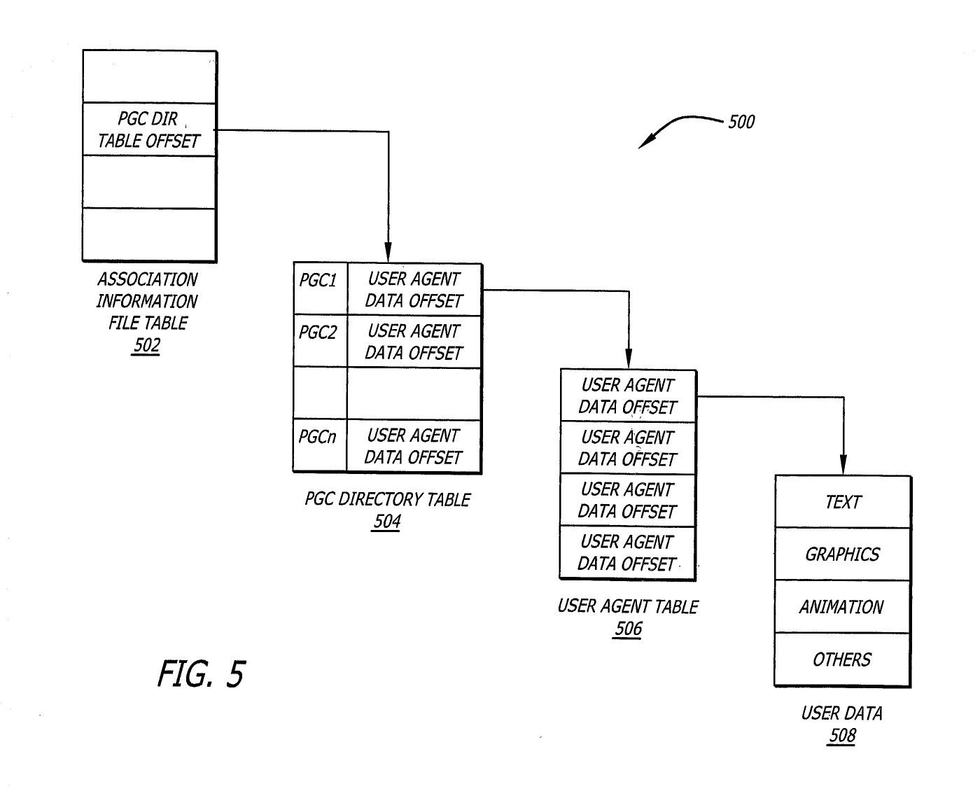

FIG. 5 illustrates a directory tree 500 comprising the association information file table 502, the PGC directory table 504, the user agent data table 506, and a user data table 508. In accordance with the video segment to user agent document association technique, the optical disc player 400 locates the association information file 502 and reads the pointer (or offset) to the PGC directory table 504. The PGC directory table 504 contains sets of PGCs 1-n and pointers (or offsets) to the corresponding sets of user agent data table 506. The user agent data table 506, in turn, contains the user agent data and also may contain pointers to text, graphics, animation, and other data objects associated with the user agent data. In this manner, the optical disc player 400 can read a PGC and the associated user agent data with the associated text, graphics, animation, and other data, for seamlessly playback of both the PGC and the associated user agent data according to the methods described below. Alternatively, the user agent table can contain pointers to the corresponding PGCs and pointers to data objects and the association information file can point to the user agent table.

Another aspect of associating the sets of user agent data with the corresponding video segments is by using methods, properties and events from a scripting language (such as JavaScript). In accordance with this method of the invention, user agent documents can trap events fired during video playback in the scripting language event-handlers (such as JavaScript custom event-handlers) and user scripting language commands (such as JavaScript custom object methods) to perform the desired action. These actions can be in the form of changing user agent documents, and/or playing a different video segment. This aspect of associating user agent documents with video data does not require user agent documents and program chains of video data to be pre-authored in files such as the association information file (explained above). Developers can handle events generated during playback and/or make scripting language method commands to change user agent documents and/or video playback.

III. Optical Disc Player Reads User Agent Data Before/After PGC Playback

The first method for providing seamless playback of video/audio data and user agent data without causing a track buffer underflow entails reading the user agent data before or after the playback of the associated PGC. According to the DVD standard specification, the requirement for providing seamless playback of video/audio data is only specified within a PGC. The seamless playback of video/audio data, however, is not required before or after the playback of a PGC or in between the playback of consecutive PGCs. Therefore, according to the first method of the invention, the reading of the user agent data is performed before or after the reading of the associated PGC. The following example illustrates this aspect of the invention.

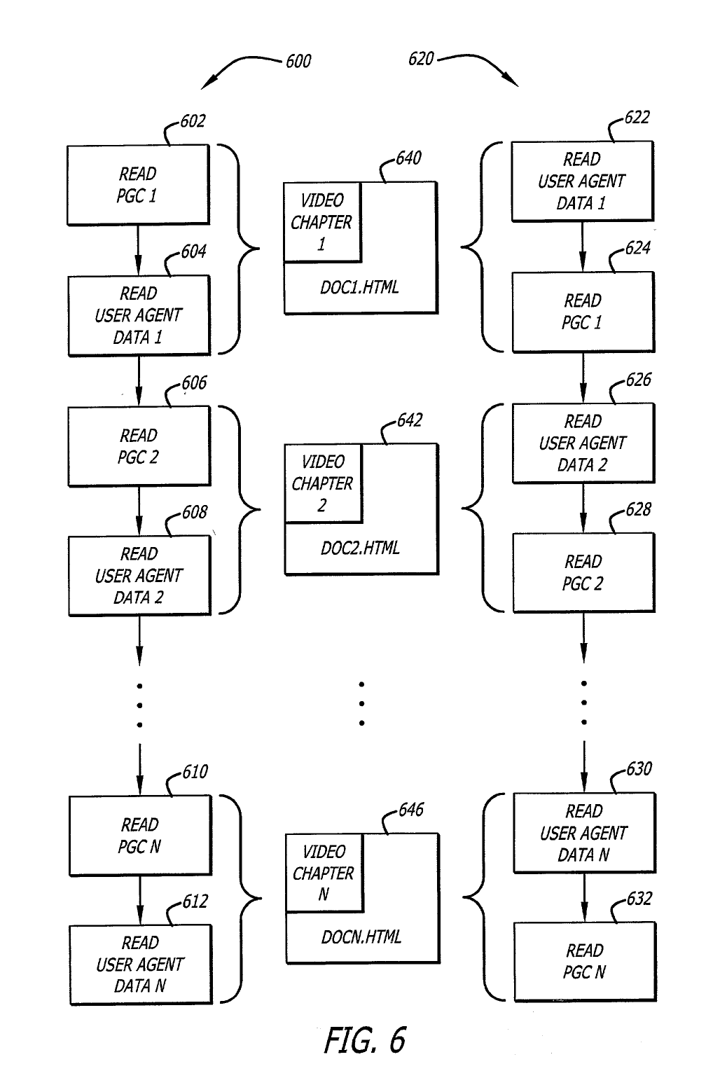

FIG. 6 illustrates flow diagrams of methods 600 and 620 of providing seamless playback of video/audio data and user agent data in accordance with the invention. According to method 600 (read PGC data first, then corresponding user agent data second), in step 602 the data read controller 406 causes the reading of PGC data 1 from the local optical disc 402 and/or the external source by way of the external source interface 405. The PGC data 1 is subsequently transferred to the track buffer 408 for decoding by the video decoder 410. After step 602 has been completed, in step 604 the data read controller 406 causes the reading of the user agent data 1 from the local optical disc 402 and/or the external source by way of the external source interface 405. The user agent data 1 is subsequently transferred to the user agent buffer 412 for decoding by the user agent viewer 414. The optical disc player 400 can cause the display of screen shot 640 which shows video chapter 1 corresponding to PGC data 1 and user agent document Doc1.HTML corresponding to user agent data 1. This process is repeated for the remaining PGC data and user agent data as illustrated in steps 606 and 608 for PGC data 2, user agent data 2, and screen shot 642, and steps 610 and 612 for PGC data N, user agent data N, and screen shot 646.

According to method 620 (read user agent data first, and PGC data second), in step 622 the data read controller 406 causes the reading of user agent data 1 from the local optical disc 402 and/or the external source by way of the external source interface 405. The user agent data 1 is subsequently transferred to the user agent buffer 412 for displaying by the user agent viewer 414. After step 622 has been completed, in step 624 the data read controller 406 causes the reading of PGC data 1 from the local optical disc 402 and/or the external source by way of the external source interface 405. The PCG data 1 is subsequently transferred to the track buffer 408 for decoding by the video decoder 410. The optical disc player 400 can cause the display of screen shot 640 which shows video chapter 1 corresponding to PGC data 1 and user agent document Doc1.HTML corresponding to user agent data 1. This process is repeated for the remaining PGC data and user agent data as illustrated in steps 626 and 628 for PGC data 2, user agent data 2, and screen shot 642, and steps 630 and 632 for PGC data N, user agent data N, and screen shot 646. Such method of reading user agent data first can be used for pre-fetching/pre-loading user agent data before fetching video data.

According to the above methods 600 and 620, the time to read the user agent data can be substantially represented by the following relationship:

$${T}_{UA} = \frac{{B}_{UA}}{{V}_{r}} \qquad Eq . 1$$

where T_{UA} represents the time to read the user agent data, B_{UA} represents the total size of the user agent data including its associated text, images, etc., and Vᵣ represents the rate at which data can be read from the local optical disc 402. Accordingly, the total time to read both the user agent data and the corresponding video/audio data can be substantially represented by the following relationship:

$$T = \frac{{B}_{UA} + {B}_{m}}{{V}_{r}} \qquad Eq . 2$$

where Bm represents the track buffer size (in sectors). If the data rate is at the minimum specification for DVD playback (i.e. Vᵣ=1× rate), seamless playback can be only guaranteed within a PGC. Video can halt between PGC playbacks while the data read controller 420 is processing requests to read user agent data. In this case, the size of the user agent data and duration of the PGC will determine the delay in the video playback. Based on the requirement, optimum values for the size of the track buffer 408, the size of the user agent buffer 412, and the PGC duration can be calculated to optimize synchronous playback.

IV. Optical Disc Player Reads User Agent Data During PGC Playback

The second method for providing seamless playback of video/audio data and user agent data without causing a track buffer underflow entails reading the PGC and the corresponding user agent data concurrently with a data rate that prevents track buffer underflow i.e. a data rate greater than the required data rate of 1×. This is done in a manner that also prevents the underflow and overflowing of the track buffer as well as the underflow and overflow of the user agent data buffer. The data can be retrieved from both the local optical disc 402 and/or an external source by way of the external source interface 405. The following explains in more detail the timing and buffer size requirements for retrieving both types of data from the local optical disc 402.

According to this method, the data read controller 406 causes the drive reading mechanism moves to read user agent data while the corresponding PGC is being played back. The read mechanism should perform the reading of the user agent data in a manner that does not produce an underflow or an overflow of the track buffer 408. In one scenario, the read drive mechanism may read enough video/audio data to substantially fill the track buffer 408, then subsequently read the user agent data while the video decoder 410 is decoding the video/audio data in the track buffer 408. To ensure seamless playback, the track buffer 408 should not overflow or underflow and the user agent buffer 412 should also not overflow or underflow. The following illustrates an example of a worst case scenario.

In the exemplary worst case scenario, the maximum time delays will be assumed in the reading of the user agent data and the video/audio data. Given these assumptions, the following relationship approximately holds for the minimum buffer size of the track buffer which prevents a track underflow from occurring. This is given by the DVD Specifications for Read-Only Disc, Part 3, Video Specifications (Annex K) as:

$${B}_{m} > = \frac{( 2 {T}_{k} + {t}_{j} + 4 {T}_{e} ) \times {MAX\_V}_{o} \times {10}^{6}}{2048 \times 8} \qquad Eq . 3$$

where Bₘ represents the size of the track buffer 408 in sectors, the Tₖ represents the latency time associated with one rotation of the local optical disc 402 in seconds, the Tₑ represents the time to read a ECC block of data in seconds, the T_{J} represents the time to seek the track and other latency time associated with the reading commands, and the MAX_Vₒ represents the maximum read out rate of the ILVU or PREU from the track buffer. In essence, the (2 Tₖ−tⱼ+4 Tₑ) represents the maximum time associated with the reading of the user agent data, MAX_Vₒ×10⁶ represents the maximum data rate flowing out of the track buffer 408, and the 2048×8 represents the conversion of the size units from bits to sectors.

Another parameter that is to be considered to prevent track buffer underflow is the minimum time MIN_T_{track} in which the track buffer 408 will underflow considering the maximum rate at which video data is being drained out of the track buffer. Within this minimum time MIN_T_{track}, video/audio data need to be fed into the track buffer 408 in order to prevent track buffer underflow. The following relationship approximately holds for MIN_T_{track}:

$${MIN\_T}_{track} = \frac{{B}_{m}}{{MAX\_V}_{o} \times {10}^{6}} \qquad Eq . 4$$

The MIN_T_{track} parameter also determines the maximum amount of time MAX_T_{UA} that the drive has to seek to and read user agent data and seek back to read video data again. The following relationship approximately holds for MAX_T_{UA}:

MAX_{—}T_{UA}=MIN_{—}T_{track}−2T_{J}−Tₑ Eq. 5

This maximum time MAX_T_{UA} for user agent data read determines the minimum user agent buffer size.

As previously discussed, another condition for providing seamless playback of user agent data and video/audio data is preventing user agent buffer underflow. In some cases, user agent data may consists of streaming data, such as an audio file or streaming video data. An underflow of the user agent buffer 412 during the transmission of streaming data to the user agent viewer 414 may cause the system 400 to pause audio/video playback. Accordingly, various parameters can be designed to ensure that the underflow of the user agent buffer 412 is prevented. One such parameter is the minimum time MIN_T_{UA} that it takes for the track buffer to drain out. The following relationship approximately holds for MIN_T_{UA}:

$${MIN\_T}_{UA} = \frac{{B}_{UA}}{{MAX\_V}_{UA}} \qquad Eq . 6$$

where again MIN_T_{UA} represents the minimum time for the user agent buffer 412 to drain out, B_{UA} represents the size of the user agent buffer, and MAX_V_{UA} represents the maximum rate at which data is being read out from the user agent buffer 412 into the user agent viewer 414.

In order to prevent an underflow of the user agent buffer 412, the minimum time MIN_T_{UA} for the user agent buffer 412 to drain out is the maximum amount of time allotted to seek and read the video/audio data and return back to read the user agent data again. Accordingly, the following relationship substantially holds:

MAX_{—}T_{track}<=(MIN_{—}T_{UA}−2Tₖ−2t_{J}−4Tₑ) Eq. 7

where MAX_T_{track} represents the maximum allowable time for video data to be read into the track buffer 408, Tₖ represents the latency time for one rotation of the local optical disc 404, T_{J} represents the track seek time, and Tₑ represents the read-in time for one ECC block of data. The maximum allowable time MAX_T_{track} for video data to be read into the Track buffer shall be less than the time it takes for the drive mechanism to seek to the video data, read video data, seek back to ROM data and read a block of ROM data. This will ensure that the user agent buffer does not underflow and will guarantee seamless playback.

V. Optical Disc Player Reads User Agent Data and Video Data Simultaneously

The third method for providing seamless playback of video/audio data and user agent data without causing a track buffer overflow and underflow entails reading the PGC and the corresponding user agent data simultaneously. This is done in a manner that prevents the underflow and overflow of the track buffer as well as the underflow and overflow of the user agent data buffer. Data can be retrieved from both a local optical disc and an external source by way of an external source interface. The following explains in more detail.

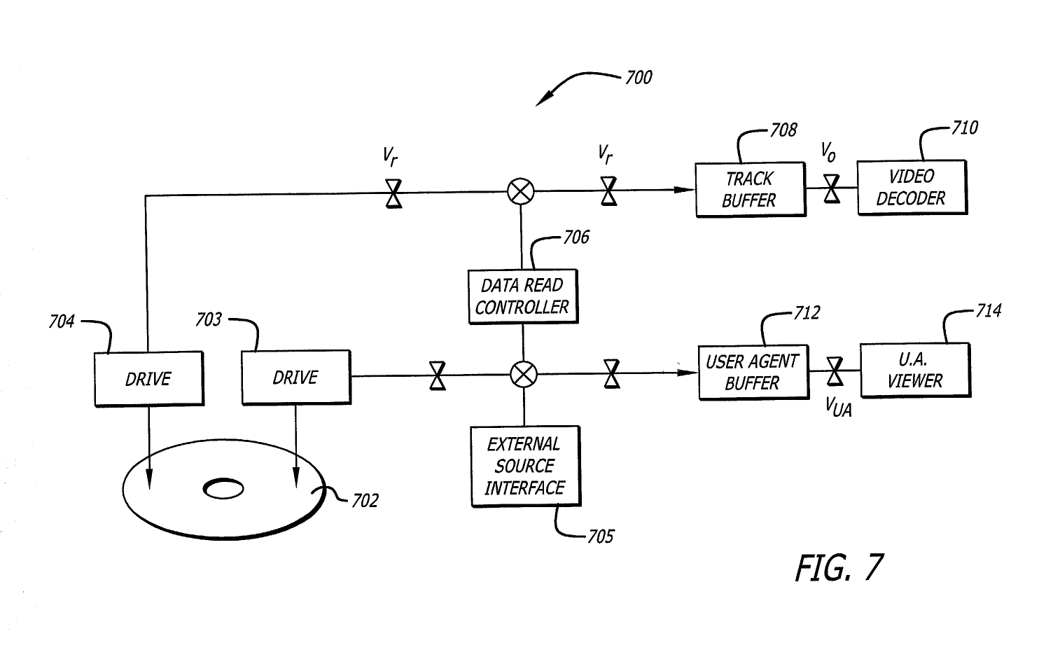

FIG. 7 illustrates a functional block diagram of an exemplary optical disc player 700 in accordance with the invention. The optical disc player 700 comprises a dual head optical disc drive including a first drive head 704 to read video/audio data from a local optical disc 702 and a second drive head 703 to read user agent data from the local optical disc 702. The optical disc player 700 further comprises an external source interface 705 to receive user agent data including video and audio streaming data. The optical disc player 700 further comprises a track buffer 708 to temporarily store video/audio data for subsequent decoding by a video decoder 710, and a user agent buffer 712 for temporarily storing user agent data for subsequent rendering by the user agent viewer 714. Also, the optical disc player 400 comprises a data read controller 706 for controlling the retrieval of the data from the local optical disc 702 and/or an external source by way of the interface 705 and subsequent transfer to the track buffer 708 and/or the user agent buffer 712.

According to this method of providing seamless playback of video/audio data and user agent data, the data read controller 706 causes the video drive 704 to read a video segment and causes the user agent data drive 703 read user agent data for the corresponding video segment being played back. The data read controller 706 controls the drive read mechanisms so that the user agent drive head 703 reads user agent data simultaneous (i.e. in synchronous) with the reading of video segment data by the video drive head 704. The data read controller 706 should cause the reading of the user agent data by the drive 703 in a manner that does not produce an underflow or an overflow of the user agent buffer 712. Similarly, the data read controller 706 should cause the reading of video data by the drive 704 in a manner that does not produce an underflow or an overflow of the track buffer 708.

VI. Conclusion

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

It is claimed:

1. A method of accessing video data and user agent data for playback by an optical disc player, comprising:
transferring a program chain of video data from a source to a track buffer while not transferring user agent data; and
transferring a set of user agent data associated with said program chain from said source to a user agent buffer while not transferring video data.

2. The method of claim 1, wherein transferring said program chain occurs before transferring said set of user agent data.

3. The method of claim 1, wherein transferring said program chain occurs after transferring said set of user agent data.

4. The method of claim 1, further comprising decoding said program chain of video data in order to display said program chain of video data.

5. The method of claim 1, further comprising decoding said set of user agent data in order to display said set of user agent data.

6. The method of claim 1, further comprising:
decoding said program chain of video data in order to display said program chain of video data; and
rendering said set of user agent data for displaying said set of user agent data concurrently with said program chain of video data.

7. The method of claim 1, wherein said source comprises a local optical disc.

8. The method of claim 1, wherein said source comprises a source external to said optical disc player.

9. The method of claim 8, wherein said external source comprises a server.

10. The method of claim 8, wherein said source external comprises an external hard drive.

11. The method of claim 8, wherein said external source comprises an external local optical disc.

12. An optical disc player, comprising:
a track buffer to temporarily store video data;
a user agent buffer to temporarily store user agent data; and
a data read controller to cause a transfer of a program chain of video data from a source to said track buffer while not transferring user agent data, and to cause a transfer of a set of user agent data associated with said program chain of video data to said user agent buffer while not transferring video data.

13. The optical disc player of claim 12, wherein said data read controller causes said transfer of said program chain before causing said transfer of said set of user agent data.

14. The optical disc player of claim 12, wherein said data read controller causes said transfer of said program chain after causing said transfer of said set of user agent data.

15. The optical disc player of claim 12, further comprising a video decoder to decode said program chain of video data in order to display said program chain of video data.

16. The optical disc player of claim 12, further comprising a user agent viewer to render said set of user agent data for displaying.

17. The optical disc player of claim 12, further comprising an optical disc reader to read said program chain and/or said set of user agent data from a local optical disc.

18. The optical disc player of claim 12, further comprising an interface to receive said program chain and/or said set of user agent data from an external source.

19. A method of accessing video data and user agent data for playback by an optical disc player, comprising:
transferring a program chain of video data from a source to a track buffer; and
transferring a set of user agent data associated with said program chain from said source to a user agent buffer concurrently with said transferring of said program chain of video data from said source to said track buffer.

20. The method of claim 19, wherein transferring said set of user agent data is performed in a manner that prevents an underflow of said track buffer.

21. The method of claim 19, wherein transferring said program chain is performed in a manner that prevents an underflow of said user agent buffer.

22. The method of claim 19, wherein transferring said set of user agent data is performed in a manner that prevents an overflow of said user agent buffer.

23. The method of claim 19, wherein transferring said program chain is performed in a manner that prevents an overflow of said track buffer.

24. The method of claim 19, further comprising decoding said program chain of video data in order to display said program chain of video data.

25. The method of claim 19, further comprising rendering said set of user agent data for displaying.

26. The method of claim 19, further comprising:
decoding said program chain of video data in order to display said program chain of video data; and
rendering said set of user agent data for displaying said set of user agent data concurrently with said program chain of video data.

27. The method of claim 19, wherein said source comprises a local optical disc.

28. The method of claim 19, wherein said source comprises a source external to said optical disc player.

29. An optical disc player, comprising:
a track buffer to temporarily store video data;
a user agent buffer to temporarily store user agent data; and
a data read controller to cause a transfer of a program chain of video data from a source to said track buffer concurrently with a transfer of a set of user agent data associated with said program chain of video data to said user agent buffer.

30. The optical disc player of claim 29, wherein said data read controller causes said transfer of said program chain in a manner that prevents an underflow of said user agent buffer.

31. The optical disc player of claim 29, wherein said data read controller causes said transfer of said program chain in a manner that prevents an overflow of said track buffer.

32. The optical disc player of claim 29, wherein said data read controller causes said transfer of said user agent data in a manner that prevents an underflow of said track buffer.

33. The optical disc player of claim 29, wherein said data read controller causes said transfer of said user agent data in a manner that prevents an overflow of said user agent buffer.

34. The optical disc player of claim 29, further comprising a video decoder to decode said program chain of video data in order to display said program chain of video data.

35. The optical disc player of claim 29, further comprising a user agent decoder to render said set of user agent data for displaying.

36. The optical disc player of claim 29, further comprising an optical disc reader to read said program chain and/or user agent data from a local optical disc.

37. The optical disc player of claim 29, further comprising an interface to receive said program chain and/or said user agent data from an external source.

38. A method of associating video data with user agent data, comprising:
providing a first directory table containing a plurality of program chains of video data and respective pointers to a plurality of sets of user agent data associated respectively with said plurality of program chains of video data.

39. The method of claim 38, further comprising providing a second directory table containing said plurality of sets of user agent data and respective pointers to objects associated respectively with said plurality of sets of user agent data.

40. A method of associating video data with user agent data, comprising:
providing a first directory table containing a plurality of sets of user agent data and respective pointers to a plurality of program chains of video data associated respectively with said plurality of sets of user agent data.

41. The method of claim 40, wherein said first directory table further contains pointers to objects associated respectively with said plurality of sets of user agent data.

42. The method of claim 40, further comprising providing a second directory table containing said plurality of program chains of video data.

43. A method of accessing video data and user agent data for playback by an optical disc player, comprising:
transferring video data from a source to a track buffer; and
transferring user agent data in synchronous with said video data from said source to a user agent buffer simultaneously with said transferring of said video data from said source to said track buffer.

44. The method of claim 43, wherein transferring said user agent data is performed in a manner that prevents an underflow of said track buffer.

45. The method of claim 43, wherein transferring said video data is performed in a manner that prevents an underflow of said user agent buffer.

46. The method of claim 43, wherein transferring said user agent data is performed in a manner that prevents an overflow of said user agent buffer.

47. The method of claim 43, wherein transferring said video data is performed in a manner that prevents an overflow of said track buffer.

48. The method of claim 43, further comprising decoding said video data in order to display said video data.

49. The method of claim 43, further comprising rendering said user agent data in order to display said set of user agent data.

50. The method of claim 43, wherein said source comprises a local optical disc.

51. The method of claim 43, wherein said source comprises a source external to said optical disc player.

52. The method of claim 43, wherein transferring said video data and transferring said user agent data comprises using two optical disc reading drives to read said video data and said user agent data simultaneous from a local optical disc.

53. An optical disc player, comprising:
a track buffer to temporarily store video data;
a user agent buffer to temporarily store user agent data;
an optical disc drive having a first reading mechanism to read video data from a local optical disc and a second reading mechanism to read user agent data from said local optical disc; and
a data read controller to cause said first reading mechanism to read video data, to cause said second reading mechanism to read user agent data simultaneous with said first reading mechanism reading of said video data, and to cause a transfer of said video data and user agent data respectively to said track buffer and said user agent buffer.

54. The optical disc player of claim 53, wherein said data read controller causes said transfer of said video data in a manner that prevents an underflow of said user agent buffer.

55. The optical disc player of claim 53, wherein said data read controller causes said transfer of said video data in a manner that prevents an overflow of said track buffer.

56. The optical disc player of claim 53, wherein said data read controller causes said transfer of said user agent data in a manner that prevents an underflow of said track buffer.

57. The optical disc player of claim 53, wherein said data read controller causes said transfer of said user agent data in a manner that prevents an overflow of said user agent buffer.

58. The optical disc player of claim 53, further comprising a video decoder to decode said video data in order to display said video data.

59. The optical disc player of claim 53, further comprising a user agent decoder to render said user agent data for displaying.

60. The optical disc player of claim 53, further comprising an interface to receive user agent data from an external source.
